(19) United States
(12) Patent Application Publication
(10) Pub. No.: US 2019/0010067 A1
(43) Pub. Date: Jan. 10, 2019

(54) BIOREACTOR ASSEMBLY

(71) Applicant: Dow Global Technologies LLC, Midland, MI (US)

(72) Inventors: Steven D. Jons, Eden Prairie, MN (US); Jon E. Johnson, Plymouth, MN (US); Tina L. Arrowood, Elko New Market, MN (US); Matthew D. Reichert, Minneapolis, MN (US)

(21) Appl. No.: 16/066,606

(22) PCT Filed: Mar. 1, 2017
(86) PCT No.: PCT/US2017/020065

§ 371 Date: Jun. 27, 2018

Related U.S. Application Data
(60) Provisional application No. 62/315,292, filed on Mar. 30, 2016.
(60) Provisional application No. 62/312,186, filed on Mar. 23, 2016.

(51) Int. Cl. C02F 3/10; B01D 63/12; B01D 61/04; C02F 1/44

(52) U.S. Cl. CPC C02F 3/109; B01D 2319/04; C02F 3/103; C02F 3/104; B01D 63/12; B01D 61/04; C02F 1/441; C02F 2203/006; C02F 2303/20; B01D 2311/04; B01D 2311/2688; B01D 2313/143; B01D 2317/02; B01D 2319/022; C02F 3/102

(57) ABSTRACT

A bioreactor assembly for treating feed water including: i) a pressure vessel comprising an inner peripheral surface defining an inner chamber having a cross-sectional area, and a first and second port adapted to provide fluid access with the inner chamber, ii) a plurality of bioreactors located within the inner chamber, wherein each bioreactor includes an outer periphery and flow channels extending along bio-growth surfaces from an inlet region to an outlet region, and iii) a fluid flow pathway adapted for connection to a source of feed water and extending from the first port of the pressure vessel, along a parallel flow pattern to each bioreactor, into the flow channels of each bioreactor, and out the second port of the pressure vessel.

### FIELD

The invention is directed toward bioreactor assemblies.

### INTRODUCTION

Many cooling and filtration devices rely upon a continuous or semi-continues flow of feed water. When the feed source contains bio-nutrients, biofouling often occurs. As a result, such devices experience a loss in heat exchange efficiency and/or an undesirable pressure drop. Moreover, when biofouling occurs on closely spaced membrane surfaces, the overall efficiency of mass transfer is adversely affected.

Biofouling may be mitigated by introducing oxidants (e.g. bleach), biocides or biostatic agents into the feed water. Feed water may also be pre-treated with a bioreactor to reduce bio-nutrients that would otherwise contribute to biofouling of downstream devices. Examples are described in US2012/0193287; U.S. Pat. No. 7,045,063, EP127243; and H. C. Hemming et al., Desalination, 113 (1997) 215-225; H. Brouwer et al., Desalination, vol. 11, issues 1-3 (2006) 15-17. In each of these examples, feed water is pre-treated with a bioreactor at a location upstream from use. See also: US2012074995, GB1509712, JP2013202548, WO199638387, DE3413551 and DE102012011816.

New techniques for removing bio-nutrients from feed water are desired. In particular, new bioreactor designs are desired, including those suited for removing the most assimilable bio-nutrients in a continuous or semi-continues manner.

### SUMMARY

In a preferred embodiment, the invention includes a bioreactor assembly for treating a feed fluid (e.g. water) including:

i) a pressure vessel comprising an inner peripheral surface defining an inner chamber having a cross-sectional area, and a first and second port adapted to provide fluid access with the inner chamber,

ii) a plurality of bioreactors located within the inner chamber, wherein each bioreactor includes an outer periphery and flow channels extending along bio-growth surfaces from an inlet region to an outlet region, and

iii) a fluid flow pathway adapted for connection to a source of feed water and extending from the first port of the pressure vessel, along a parallel flow pattern to each bioreactor, into the flow channels of each bioreactor, and out the second port of the pressure vessel.

In a preferred embodiment, the bioreactors are positioned in a serial arrangement within the inner chamber of the pressure vessel. In another embodiment, a plurality of assemblies including multiple pressure vessels with multiple bioreactors may be used.

The bioreactor assembly may serve as a pre-treatment for water used in downstream operations, including heating or cooling (e.g. heat exchangers, humidifiers, cooling towers, etc.) and filtration (e.g. reverse osmosis, nanofiltration, forward osmosis, ultrafiltration, microfiltration, cartridge filters, membrane distillation, membrane degasification, etc.) devices. Absent the reduction in bio-nutrients in the feed water, such downstream operations may experience significant biofouling that can reduce efficiency.

### BRIEF DESCRIPTION OF THE DRAWINGS

The figures are not to scale and include idealized views to facilitate description. Where to possible, like numerals have been used throughout the figures and written description to designate the same or similar features.

FIG. 1 is a perspective, partially cut-away view of a spiral wound membrane module.

FIGS. 2A-B are cross-sectional views of various embodiments of hyperfiltration assemblies including a plurality of spiral wound membrane modules serially arranged within a pressure vessel.

FIGS. 3A-B are elevation views of spiral wound bioreactors.

FIG. 3C is a perspective view of a spiral wound bioreactor.

FIG. 4-B are a cross-sectional view of a bioreactor assembly including a pressure vessel and a plurality of bioreactors in a parallel alignment and in a parallel flow arrangement.

FIGS. 5A-D are a cross-sectional views of bioreactor assemblies including a plurality of spiral wound bioreactors axially aligned and positioned in a parallel flow arrangement within a pressure vessel. In the embodiment shown in FIGS. 5A-B, the bioreactors are aligned along an axis (Y) that coincides with a central axis (Y′) of the pressure vessel; whereas in the embodiment shown in FIGS. 5C-D, the axis of alignment for the bioreactors (Y) is parallel but offset from the central axis (Y′) of the bioreactor. Arrows depict a fluid flow pathway through the assembly.

FIG. 6A is a cross section of a bioreactor assembly including a bioreactor located within a pressure vessel and illustrating a radial flow feed channel (68).

FIG. 6B is a perspective view of a bioreactor suitable for radial flow between an outer peripheral surface and a hollow central conduit.

FIGS. 7A-D are cross-sectional views showing alternative embodiments of bioreactor assemblies including a plurality of bioreactors having a porous outer peripheral surface and fluid flow pathways extending from a porous outer peripheral surface and to a hollow central conduit.

FIG. 8 is a schematic view of an embodiment of the subject assembly including a plurality of upstream bioreactor assemblies, a plurality of downstream separation modules, and an optional cleaning assembly.

### DETAILED DESCRIPTION

The invention includes a bioreactor assembly useful for treating various aqueous feeds (e.g. brackish water, sea water, waste water, etc.) that include bio-nutrients (e.g. dissolved and suspended biological matter). The bioreactor includes flow channels extending along bio-growth surfaces from an inlet region to an outlet region. Incoming feed fluid enters the inlet region and passes through the flow channels to the outlet region. The bio-growth surfaces (growth media) provide a platform for microorganisms to colonize and consume bio-nutrients in the feed fluid as it passes through the bioreactor. As will be described, several embodiments of bio-growth surfaces are suitable, including flat sheets, particles, etc. The inlet region and outlet region are located adjacent to the growth media to and do not necessarily correspond to the outer-most dimensions of a bioreactor where feed fluid may enter and exit.

In a preferred embodiment, the bioreactor assembly includes at least one, and preferably a plurality of bioreactors located within an inner chamber of a pressure vessel. The pressure vessel includes a first and second port adapted to provide fluid access to an inner chamber. A fluid flow pathway extends from the first port, into the inlet region of the bioreactor and through the flow channels of the bioreactor and out the outlet region of the bioreactor and second port of the pressure vessel. The fluid flow pathway is adapted to connection to a source of feed fluid. An inner peripheral surface of the pressure vessel defines an inner chamber that is preferably cylindrical and the bioreactor preferably includes a cylindrical outer periphery.

While a plurality of bioreactors may be positioned in a parallel or serial arrangement within a common pressure vessel, the fluid flow pathway is preferably follows a parallel flow pattern through bioreactor.

In preferred embodiments, the inner chamber of the pressure vessel extends along an axis (Y′) between opposing ends. At least 15% (and more preferably 20%, 25% or even 30%) of the cross-sectional area (i.e. taken in a perpendicular direction to axis Y′ and at any location along the axis Y′) of the inner chamber, excluding the area of the flow channels (of bioreactors that may be located at the point at which the cross section is measured), is free space accessible to the fluid flow pathway. This arrangement provides adequate fluid flow through the inner chamber to supply each bioreactor with a parallel flow of feed fluid with reduced pressure drop.

As will be described, a variety of bioreactor configurations may be used. For example, the bioreactor may include a central hollow conduit, a porous cylindrical shell and a particulate or filamentous growth media; the growth media provides the bio-growth surfaces and defines flow channels therebetween that fluidly connect the central hollow conduit and the porous cylindrical shell. In an alternative embodiment, the bioreactor may include a flat sheet having two opposing bio-growth surfaces and a feed spacer spirally wound about an axis (Y) to form a cylindrical outer peripheral surface. The flat sheet may be porous or non-porous, and the feed spacer provides flow channels between adjacent bio-growth surfaces that provide a path for fluid to pass through the bioreactor without passing through the flat sheet.

The bioreactor assembly may be used as pre-treatment for water used in a downstream cooling/heating or filtration device—particularly those that are vulnerable to biofouling and otherwise difficult or expensive to clean. Examples of heating and cooling devices include: heat exchangers, humidifiers, and cooling towers. Examples of filtration device include: reverse osmosis, nanofiltration, forward osmosis, ultrafiltration, microfiltration, membrane distillation, membrane degasification units. The bioreactor assembly is conducive to pre-treating a continuous flow of water and removing the most assimilable food from the water to prevent or delay biofouling in the downstream device. A plurality of bioreactor assemblies in parallel within a larger treatment assembly enables the periodic removal and cleaning of individual bioreactor assemblies while still providing a continuous supply of pre-treated water to a downstream device that would otherwise be subject to fouling.

In a preferred embodiment, the downstream device is a reverse osmosis (RO) or nanofiltration (NF) apparatus, collectively referred to as “hyperfiltration”. The hyperfiltration assembly includes: a) a high pressure vessel including a feed port, concentrate port and permeate port, and b) a plurality of serially arranged spiral wound hyperfiltration membrane modules located within the high pressure vessel and each including at least one membrane envelope wound around a permeate tube forming a permeate pathway to the permeate port. With such an arrangement, bio-nutrients present in the feed fluid are consumed by microorganisms present in the bioreactor assembly and are less available to cause biofouling in the downstream hyperfiltration assembly.

The hyperfiltration assembly includes a plurality of spiral wound membrane modules located in a serial arrangement and serial flow pattern within a common (high) pressure vessel. In operation, a source of pressurized feed fluid (e.g. waste water pressurized to 0.1 to 1 MPa) passes along a fluid flow pathway successively through the bioreactor assembly and hyperfiltration assembly. Additional filter unit operations may be included along the fluid flow pathway. For example, a microfiltration device (average pore diameter of from 0.1 to 10 μm) or ultrafiltration device (average pore diameter of 0.001-0.1 μm) e.g. hollow fiber membrane module, or cartridge filter (average pore diameter of from 10 to 50 μm) may be positioned along the fluid flow pathway at a location including between the hyperfiltration assembly and the bioreactor assembly and between a feed fluid source and the bioreactor assembly. Various combinations of one or more bioreactor assemblies may be used with one or more hyperfiltration assemblies. For example, a single bioreactor assembly may supply pre-treated fluid to a plurality of hyperfiltration assemblies, either positioned in a parallel flow configuration with each other, or in a serial configuration wherein either permeate or concentrate from a first (upstream) hyperfiltration assembly is supplied to a downstream hyperfiltration assembly. Similarly, multiple bioreactors arranged in a parallel flow configuration may supply one or more common downstream hyperfiltration assembly.

Spiral wound hyperfiltration membrane modules (“elements”) useful in the present invention include one or more membrane envelops and feed spacer sheets wound around a permeate collection tube. RO membranes used to form envelops are relatively impermeable to virtually all dissolved salts and typically reject more than about 95% of salts having monovalent ions such as sodium chloride. RO membranes also typically reject more than about 95% of inorganic molecules as well as organic molecules with molecular weights greater than approximately 100 Daltons. NF membranes are more permeable than RO membranes and typically reject less than about 95% of salts having monovalent ions while rejecting more than about 50% (and often more than 90%) of salts having divalent ions—depending upon the species of divalent ion. NF membranes also typically reject particles in the nanometer range as well as organic molecules having molecular weights greater than approximately 200 to 500 Daltons.

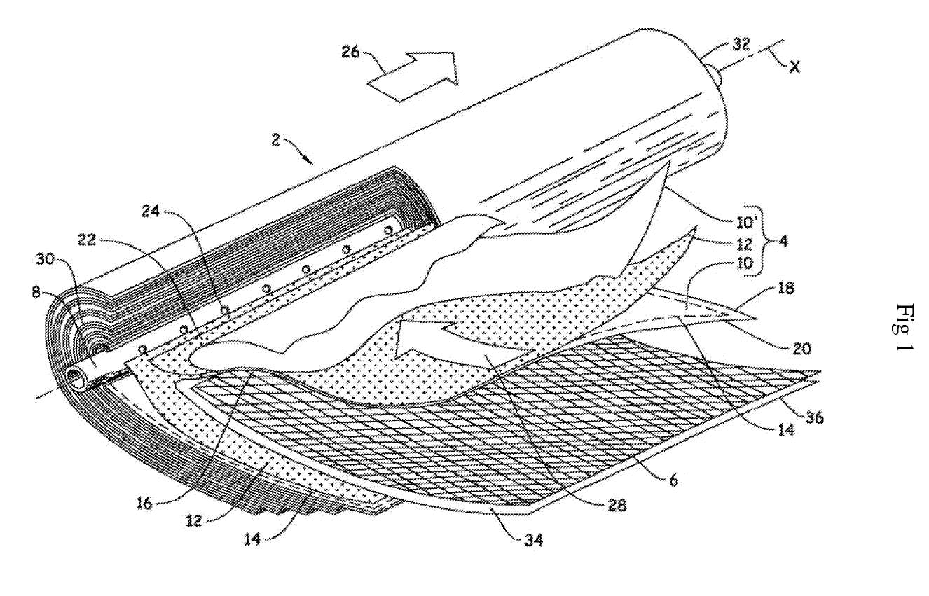

A representative spiral wound membrane module is generally shown in FIG. 1. The module (2) is formed by concentrically winding one or more membrane envelopes (4) and feed spacer sheet(s) (“feed spacers”) (6) about a permeate collection tube (8). Each membrane envelope (4) preferably comprises two substantially rectangular sections of membrane sheet (10, 10′). Each section of membrane sheet (10, 10′) has a membrane or front side (34) and support or back side (36). The membrane envelope (4) is formed by overlaying membrane sheets (10, 10′) and aligning their edges. In a preferred embodiment, the sections (10, 10′) of membrane sheet surround a permeate channel spacer sheet (“permeate spacer”) (12). This sandwich-type structure is secured together, e.g. by sealant (14), along three edges (16, 18, 20) to form an envelope (4) while a fourth edge, i.e. “proximal edge” (22) abuts the permeate collection tube (8) so that the inside portion of the envelope (4) (and optional permeate spacer (12)) is in fluid communication with a plurality of openings (24) extending along the length of the permeate collection tube (8). The module (2) preferably comprises a plurality of membrane envelopes (4) separated by a plurality of feed spacers sheets (6). In the illustrated embodiment, membrane envelopes (4) are formed by joining the back side (36) surfaces of adjacently positioned membrane leaf packets. A membrane leaf packet comprises a substantially rectangular membrane sheet (10) folded upon itself to define two membrane “leaves” wherein the front sides (34) of each leaf are facing each other and the fold is axially aligned with the proximal edge (22) of the membrane envelope (4), i.e. parallel with the permeate collection tube (8). A feed spacer sheet (6) is shown located between facing front sides (34) of the folded membrane sheet (10). The feed spacer sheet (6) facilitates flow of feed fluid in an axial direction (i.e. parallel with the permeate collection tube (8)) through the module (2). While not shown, additional intermediate layers may also be included in the assembly. Representative examples of membrane leaf packets and their fabrication are further described in U.S. Pat. No. 7,875,177.

During module fabrication, permeate spacer sheets (12) may be attached about the circumference of the permeate collection tube (8) with membrane leaf packets interleaved there between. The back sides (36) of adjacently positioned membrane leaves (10, 10′) are sealed about portions of their periphery (16, 18, 20) to enclose the permeate spacer sheet (12) to form a membrane envelope (4). Suitable techniques for attaching the permeate spacer sheet to the permeate collection tube are described in U.S. Pat. No. 5,538,642. The membrane envelope(s) (4) and feed spacer(s) (6) are wound or “rolled” concentrically about the permeate collection tube (8) to form two opposing scroll faces (30, 32) at opposing ends and the resulting spiral bundle is held in place, such as by tape or other means. The scroll faces of the (30, 32) may then be trimmed and a sealant may optionally be applied at the junction between the scroll face (30, 32) and permeate collection tube (8), as described in U.S. Pat. No. 7,951,295. Long glass fibers may be wound about the partially constructed module and resin (e.g. liquid epoxy) applied and hardened. In an alternative embodiment, tape may be applied upon the circumference of the wound module as described in U.S. Pat. No. 8,142,588. The ends of modules may be fitted with an anti-telescoping device or end cap (not shown) designed to prevent membrane envelopes from shifting under the pressure differential between the inlet and outlet scroll ends of the module. Representative examples are described in: U.S. Pat. No. 5,851,356, U.S. Pat. No. 6,224,767, U.S. Pat. No. 7,063,789, U.S. Pat. No. 7,198,719 and WO2014/120589.

Arrows shown in FIG. 1 represent the approximate flow directions (26, 28) of feed and permeate fluid (also referred to as “product” or “filtrate”) during operation. Feed fluid enters the module (2) from an inlet scroll face (30) and flows across the front side(s) (34) of the membrane sheet(s) and exits the module (2) at the opposing outlet scroll face (32). Permeate fluid flows along the permeate spacer sheet (12) in a direction approximately perpendicular to the feed flow as indicated by arrow (28). Actual fluid flow paths vary with details of construction and operating conditions.

While modules are available in a variety of sizes, one common industrial RO module is available with a standard 8 inch (20.3 cm) diameter and 40 inch (101.6 cm) length. For a typical 8 inch diameter module, 26 to 30 individual membrane envelopes are wound around the permeate collection tube (i.e. for permeate collection tubes having an outer diameter of from about 1.5 to 1.9 inches (3.8 cm-4.8 cm)). Less conventional modules may also be used, including those described in U.S. Pat. No. 8,496,825. In a preferred embodiment, at least one spiral wound hyperfiltration modules downstream of the bioreactor assembly uses a feed spacer of less than 20 mil (0.508 mm) or even less than 15 mil (0.381 mm) thickness.

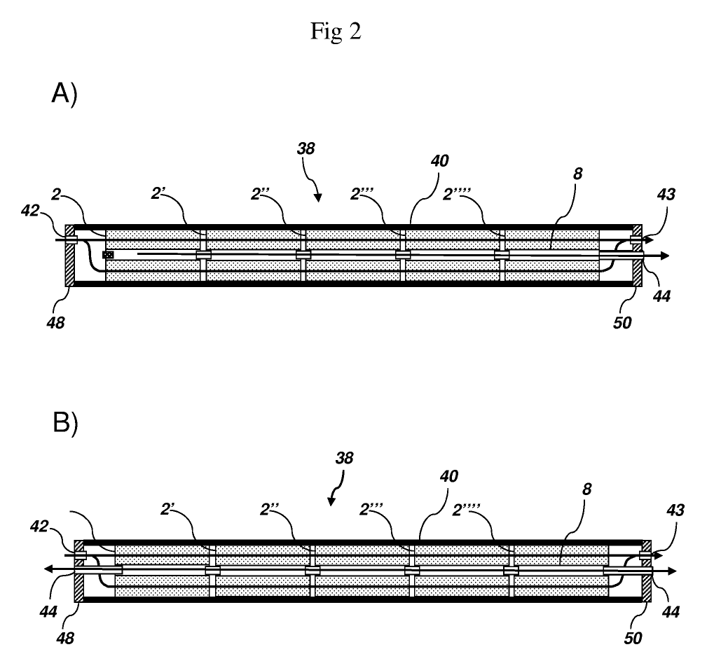

FIGS. 2A-B illustrate two classic embodiments of hyperfiltration assemblies (38) suitable for the present invention. As shown, the assembly (38) includes a high pressure vessel (40) including a feed port (42), concentrate port (43) and permeate port (44). A variety of similar configurations including combinations of ports located at the sides and ends of the pressure (40) are known and may be used. A plurality of spiral wound membrane modules (2, 2′, 2″, 2′″, 2″″) are serially arranged within the pressure vessel (40). The pressure vessel used in the present invention is not particularly limited but preferably include a solid structure capable of withstanding pressures associated with operating conditions. As fluid pressures used during operation typically exceed 1.5 MPa (e.g. 1.6 to 2.6 M for brackish water, 6 to 8 MPa for seawater), pressure vessels used in hyperfiltration are referred to herein as “high” pressure vessels. The vessel structure preferably includes a chamber (46) having an inner periphery corresponding to that of the outer periphery of the spiral wound membrane modules to be housed therein, e.g. cylindrical. The length of the chamber preferably corresponds to the combined length of the spiral wound membrane modules to be sequentially (axially) loaded. Preferably, the vessel contains at least 2 to 8 spiral wound membrane modules arranged in series with their respective permeate tubes (8) in fluid communication with each other to form a permeate pathway to the permeate port (44). Fluid flow into the feed port (42) and out the concentrate and permeate ports (43, 44) are generally indicated by arrows. The pressure vessel (40) may also include one or more end plates (48, 50) that seal the chamber (46) once loaded with modules (2). The orientation of the pressure vessel is not particularly limited, e.g. both horizontal and vertical orientations may be used. Examples of applicable pressure vessels, module arrangements and loading are described in: U.S. Pat. No. 6,074,595, U.S. Pat. No. 6,165,303, U.S. Pat. No. 6,299,772, US2007/0272628 and US2008/0308504. Manufacturers of pressure vessels include Pentair of Minneapolis Minn., Protec-Arisawa of Vista Calif. and Bel Composite of Beer Sheva, Israel.

An individual pressure vessel or a group of vessels working together, each equipped with one or more spiral wound membrane modules, can be referred to as a “train” or “pass.” The vessel(s) within the pass may be arranged in one or more stages, wherein each stage contains one or more vessels operating in parallel with respect to a feed fluid. Multiple stages are arranged in series, with the concentrate fluid from an upstream stage being used as feed fluid for the downstream stage, while the permeate from each stage is collected without further reprocessing within the pass. Multi-pass hyperfiltration systems are constructed by interconnecting individual passes along a fluid pathway as described in: U.S. Pat. No. 4,156,645, U.S. Pat. No. 6,187,200, U.S. Pat. No. 7,144,511 and WO2013/130312.

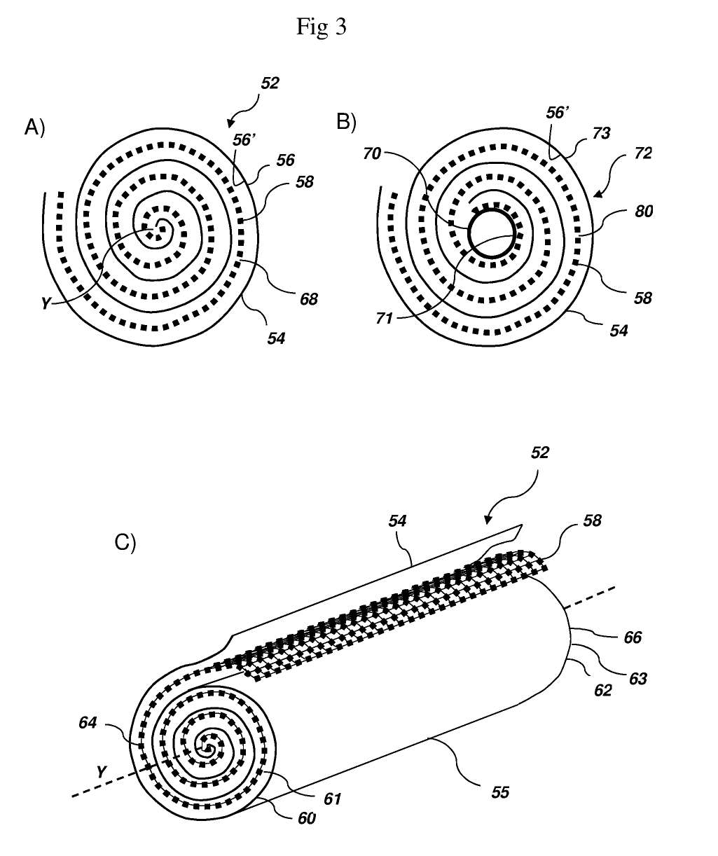

One preferred type of bioreactor has a spiral wound configuration similar to that described above with respect to the membrane modules. However, as no fluid separation occurs in the bioreactor, the bioreactor preferably includes no membrane envelope. As best shown in FIGS. 3A-C, applicable bioreactors (52) may include a flat sheet (54) having two opposing bio-growth surfaces (56, 56′) and a feed spacer (58) spirally wound about an axis (Y) to form a cylindrical outer periphery (55) extending along axis (Y) from an inlet region (61) at a first end (60) to an outlet region (63) at a second end (62), with an inlet scroll face (64) located near the first end (60) and an outlet scroll face (66) located near the second end (62). The flat sheet (54) may be porous or non-porous, and the feed spacer (58) provides flow channels between adjacent bio-growth surfaces (56, 56′) that provide a fluid flow pathway for fluid to pass through the bioreactor (52) without passing through the flat sheet (54).

In specific regard to the embodiment illustrated in FIG. 3B, the flat sheet (54) and spacer (58) are spirally wound about a hollow conduit (70). The inner surface (71) of the conduit (70) is preferably in fluid communication with the flat sheet and feed spacer only through the inlet or outlet scroll faces (64, 66). By contrast, embodiments shown in FIGS. 3A and 3C do not include a hollow conduit. In an alternative embodiment not shown, the hollow conduit may be replaced with a solid rod. While shown in FIG. 3B as including a hollow conduit (70), in other embodiments the conduit of the bioreactor is preferably impermeable and thus sealed from direct fluid communication with the flat sheet and feed spacer, except through the ends of the conduit.

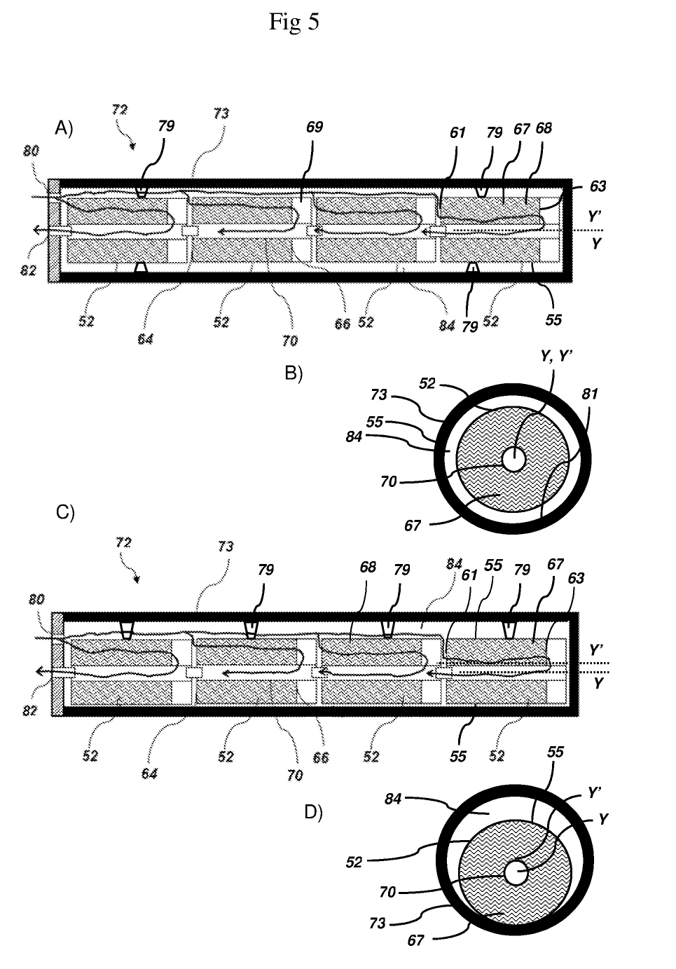

The bioreactors (52) do not function as spiral wound membrane modules in that their flat sheet does not separate the feed solution into permeate and concentrate streams. Rather, flow channels (68) provide a direct path from the inlet region (61) to the outlet region (63) without to passing through the flat sheet (54) to produce a permeate. For example, in the embodiment of FIG. 3, feed fluid passes into an inlet scroll face (64) of the spiral wound bioreactor (52), passes along flow channels (68) of the feed spacer (58) and exits via an outlet scroll face (66). However, in some embodiments, feed flowing through the flow channels may be routed back through the bioreactor by way of the center conduit (70). Such an embodiment is described in connection with FIG. 5, where fluid flow enters the conduit (70) after passing through the outlet scroll face (66). While passing through the bioreactor (52), liquid (e.g. water) contacts the flat sheet (54) which provides a platform for microorganisms to reside. Nutrients in the feed are consumed by microorganisms, so that liquid exiting the bioreactor is depleted of nutrients, e.g. prior to passing to downstream spiral wound membrane modules.

The feed spacer (58) preferably provides flow channels (68) of between 0.1 mm and 1.5 mm and more preferably between 0.15 mm and 1.0 mm, between adjacent bio-growth surfaces (56, 56′). A channel of less than 0.15 mm is more easily occluded by bio-growth, so that pressure drop through the flow channels requires more frequent cleanings. A channel of greater than 1.0 mm is less efficient at creating bio-growth that is desired to consume bio-nutrients. The spiral wound bioreactor (52) may be made with more than one overlapping flat sheet and spacer, but it is preferred to use at most two flat sheets (54) separated by spacers (58). Most preferably, each bioreactor comprises only a single spiral wound flat sheet (54).

Bio-growth surfaces are defined as those surfaces adjacent the flow channels (68) that connect the inlet region (61) and outlet region (63). In FIG. 3, growth surfaces are adjacent to flow channels (68) that connect the inlet scroll face (64) and outlet scroll face (66) of the spiral wound bioreactor (52). In order to operate at high flow rates while removing the bulk of bio-nutrients, a large area of bio-growth surface contacting the flow channels is desired, while still providing minimal resistance to flow through the bioreactor. Preferably, the void volume (volume not occupied by a solid between bio-growth surfaces) of flow channels comprises at least 65% (more preferably 75% or even 85%) of the volume of the bioreactor. The ratio of bio-growth surface area to bioreactor volume for each bioreactor is preferably between 15 cm⁻¹ and 150 cm⁻¹ (more preferably between 20 cm⁻¹ and 100 cm⁻¹). In one embodiment, a flat sheet may provide bio-growth surfaces whereas flow channels may be provided by the space between or by way of a spacer material including grooves or flow pathways (e.g. woven material, etc.)

The feed spacer (58) to be used within a spiral wound bioreactor (52) is not particularly limited and includes the feed spacers described above in connection with spiral wound membrane modules. It is desired that the majority of flat sheet adjacent a spacer is not occluded by contact with the spacer. Preferred structures for spacers include a net-like sheet material having intersection points of greater thickness than the average thickness of strands therebetween. The spacer may be a collection of raised regions of the flat sheet, such as formed by a bossing step, by application of adhesive lines to the flat sheet, or by affixing of appropriately-sized core/shell balls to the surface. Once spirally wound, the feed spacer preferably provides flow channels of from 0.10 mm to 1.5 mm, more preferably 0.15 mm to 1.0 mm, between adjacent bio-growth surfaces of the flat sheet. When provided in a sheet format, proximate feed spacer (58) and flat sheet (54) sections may be selectively bound together, e.g. adhered together along portions of their periphery or intermittent regions on their surfaces. Similarly, adjacent bio-growth surfaces may be affixed at some locations to prevent relative movement therebetween, but still allow feed movement through the flow channel. Such bonding adds strength to the bioreactor, preventing extrusion of the spacer and mitigating telescoping.

The flat sheet (54) of a bioreactor (52) may be impermeable. Alternatively, to aid in cleaning, the opposing bio-growth surfaces (56, 56′) may be in fluid communication with each other through the matrix of a porous flat sheet (54). While not particularly limited, a permeable flat sheet may include a generally impermeable sheet with perforations, a UF or MF membrane, a woven or nonwoven material, fibrous matrix, etc. Examples of suitable materials are described in U.S. Pat. No. 5,563,069. However, unlike the general design described in U.S. Pat. No. 5,563,069, the flat sheet in a spiral wound bioreactor of the present invention includes bio-growth surfaces (56, 56′) on both outer faces which are separated by a feed spacer (58). Also, while the flat sheet (54) may be either permeable or impermeable, the feed spacer (58) provides flow channels (68) between adjacent bio-growth surfaces (56, 56′) that provide a path for fluid to pass through the bioreactor (52), from an inlet region (61) to an outlet region (63), without passing through the flat sheet (54). Preferred materials include polymer sheets having pore sizes greater than 0.1 μm, or greater than 10 μm. The polymer sheet may also include macropores of sizes greater than 10 μm which facilitate disturbing fluid into fouled regions during cleaning. Applicable polymers include but are not limited to polyethylene, polypropylene, polysulfone, polyether sulfone, polyamides, and polyvinylidene fluoride. As the bioreactor of this invention preferably operates at relatively high flow rates, the flat sheet thickness is preferably less than the spacer thickness. Preferably, the flat sheet thickness is less than 1 mm, and more preferably less than 0.5 mm, less than 0.2 mm, or even less than 0.1 mm. The thickness of the flat sheet (54) in bioreactors (52) is preferably less than 25% of the thickness of a membrane envelope (4) in downstream hyperfiltration modules (2).

In embodiments where the subject bioreactor assembly is located upstream from a downstream hyperfiltration assembly, the unrolled length of flat sheet (54) from a bioreactor (52) preferably exceeds the unrolled length of a membrane envelope (4) from a downstream hyperfiltration module (2) by at least a factor of three, and more preferably by at least a factor of ten. (In this context, the unrolled lengths of flat sheet (54) and membrane envelope (4) are measured in the direction perpendicular to a central axis (X or Y, respectively, from FIGS. 1 and 3).

The outer peripheral surface (55) of the spiral wound bioreactor (52) is preferably cylindrical and may be finished in the same manner as described above with respect to spiral wound membrane modules, e.g. tape, fiberglass, etc. The bioreactor may alternatively be encased in a molded, shrink-wrapped, or extruded shell (e.g. PVC or CPVC). Alternatively or additionally, the bioreactor may include anti-telescoping devices which are commonly used in connection with spiral wound membrane modules. In one embodiment, the bioreactor includes an end cap that interlocks with an adjacent spiral wound membrane module (see for example U.S. Pat. No. 6,632,356 and U.S. Pat. No. 8,425,773). In another embodiment, to prevent mixing of the feed that has been treated by the bioreactor with feed that has not been treated, the end cap may provide seals for connecting to collection chambers inside the pressure vessel. In another embodiment, the end cap may provide seals and/or locking features for connecting to adjacent bioreactors.

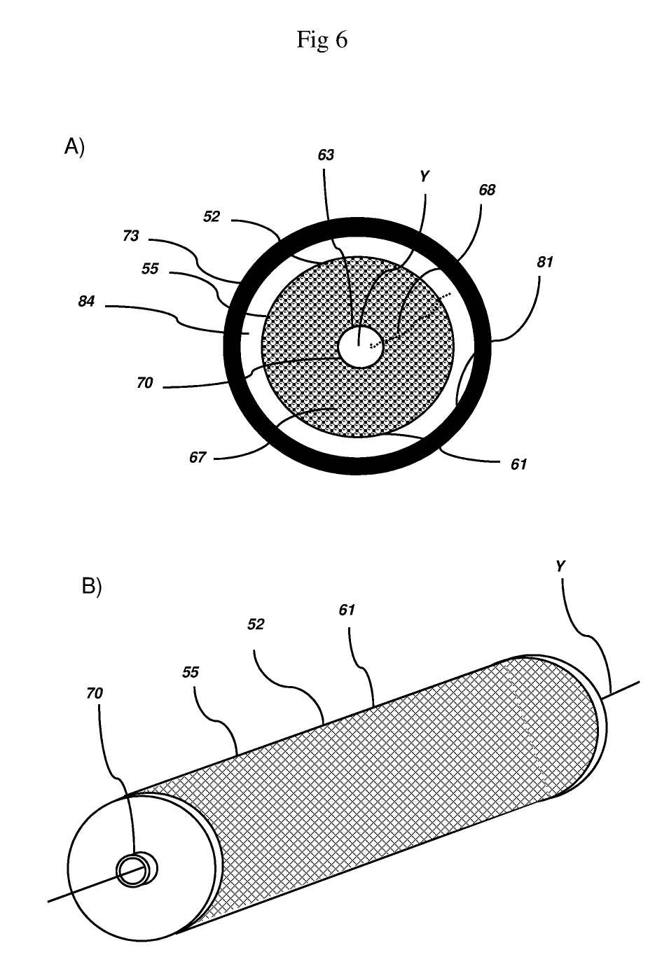

The bioreactor used within the bioreactor assembly of this invention may take different forms. An alternative to the spiral wound bioreactor of FIG. 3 is illustrated in FIG. 6. In this embodiment, the bioreactor comprises a porous outer surface (55), a central hollow conduit (70) and flow channels (68) between adjacent bio-growth surfaces that provide a fluid flow pathway for fluid to pass through the bioreactor (52), from an inlet region (61) to an outlet region (63). Radial flow is supported by end caps or seals on the opposing ends of the bioreactor. In one embodiment, the assembly may include a spiral wound module with sheet and feed spacer as described previously, but having radial flow between the periphery and center. In an alternative embodiment, the porous outer surface (55) in FIG. 6 may surround a flat sheet media as previously described, or an alternative media (67) (e.g. particles, fibers, netting, etc.) for supporting bio-growth. In addition to blocking feed flow through the opposing ends to promote radial flow within the bioreactor, end caps may be used to further contain the media. The media (67) provides bio-growth surfaces that define flow channels fluidly connecting the central hollow conduit with the surrounding porous outer surface. In these radial flow embodiments, the inlet (or outlet) region of the bioreactor may be either the porous outer surface or a locality proximate both the bio-growth media (67) and hollow conduit (70). The outlet region of the bioreactor, where flow leaves the growth-media, is the opposite. Preferably, the porous outer surface is the inlet region and the outlet region is adjacent the central hollow conduit.

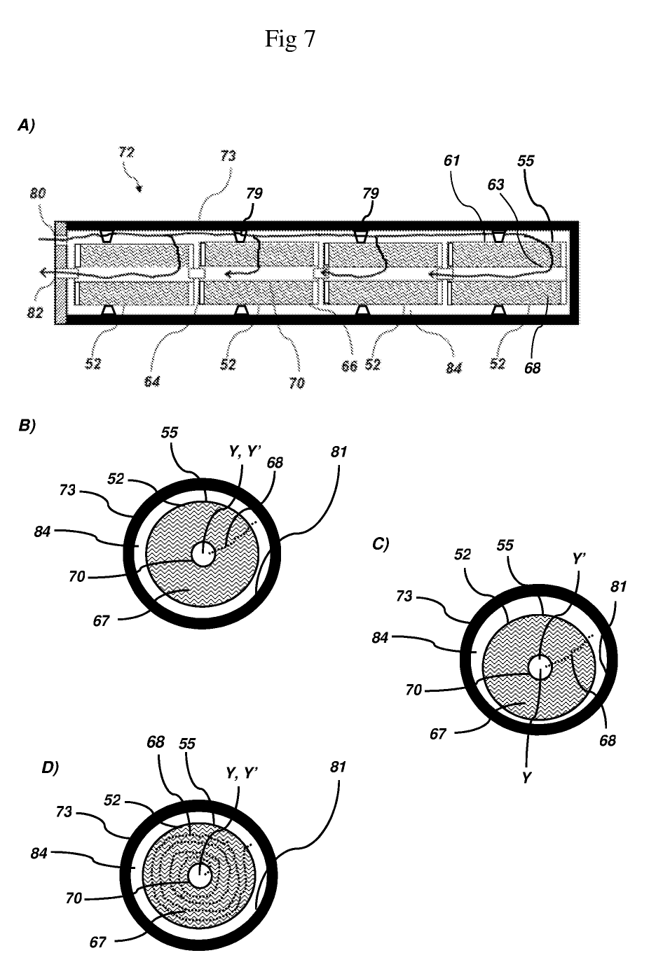

As shown in FIGS. 5 and 7, one or more spacers (79) may be used to align the bioreactor (52) within the pressure vessel (73). A plurality of spacers can separate the inner peripheral surface (81) of the pressure vessel form the outer peripheral surface (55) of the bioreactors and create an annular flow path therebetween. In another embodiment, bioreactors of smaller size than the pressure vessel's inner chamber (84) may rest by gravity on its inner surface, and potential movement of bioreactors within the vessel is restrained by stops located near the ends of bioreactors and in contact with vessels inner peripheral surface (81). In still other embodiments, the position of the bioreactors within the vessel may be fixed by attachment of a central hollow conduit to a vessel end adapter. In some embodiments, the pressure vessel includes a cylindrical inner chamber (84), having a cylindrical inner peripheral surface (81) and a central axis Y′. A preferred embodiment includes cylindrical bioreactors within a cylindrical inner chamber of a pressure vessel. In some embodiments, the pressure vessel has an aspect ratio (length/diameter) of greater than 20. In some embodiments, the bioreactor has an aspect ratio (length/diameter) of less than 4. FIG. 5B shows an embodiment wherein the central axis of the bioreactor (Y) and pressure vessel (Y′) are coincident. In FIGS. 5A and 5B, the bioreactors are shown centered within the pressure vessel. By contrast, FIGS. 5C and 5D illustrate corresponding embodiments where bioreactors (52) in series are positioned by spacers (79) off-center within the pressure vessel (73), so that Y and Y′ are parallel but off-set. In some cases, this off-center positioning may reduce overall resistance to feed flow within the vessel. The ratio between the largest and smallest distances between the outer bioreactor surface (55) and the vessel's inner peripheral surface (81) is preferably more than 2. In either case, a plurality of spacers (79) preferably separate the bioreactors from the inner peripheral surface of a pressure vessel. In some cases, it may be necessary to provide a coupler or modify vessel end adapters so that the conduit (70) may be off-center. Spacers (79) create a flow path between bioreactors and the pressure vessel so that a feed solution entering or leaving the vessel may be freely transported within this “free space” to at least half, and potentially all, of the bioreactors within a pressure vessel. As another alternative to using spacers, a plurality of smaller diameter bioreactors within a larger diameter pressure vessel may be fixed in place using a central rod or tube that passes through a bioreactor and is anchored to a vessel end adapter.

In preferred embodiments, the cross-sectional area of the bioreactor(s) is always at least 5% and more preferably less than 10% of the cross-sectional area of the inner chamber of the pressure vessel (wherein the cross sectional area is measured at any location along the length of the inner chamber). Moreover, at least 5% and more preferably 10% of the total cross sectional area of the inner chamber of the pressure vessel between its opposing ends is free space (not occupied by a bioreactor, spacers or other structure) and as such, is accessible to the fluid flow pathway. Such an arrangement provides the means to distribute flow amongst different serially aligned bioreactors in a vessel.

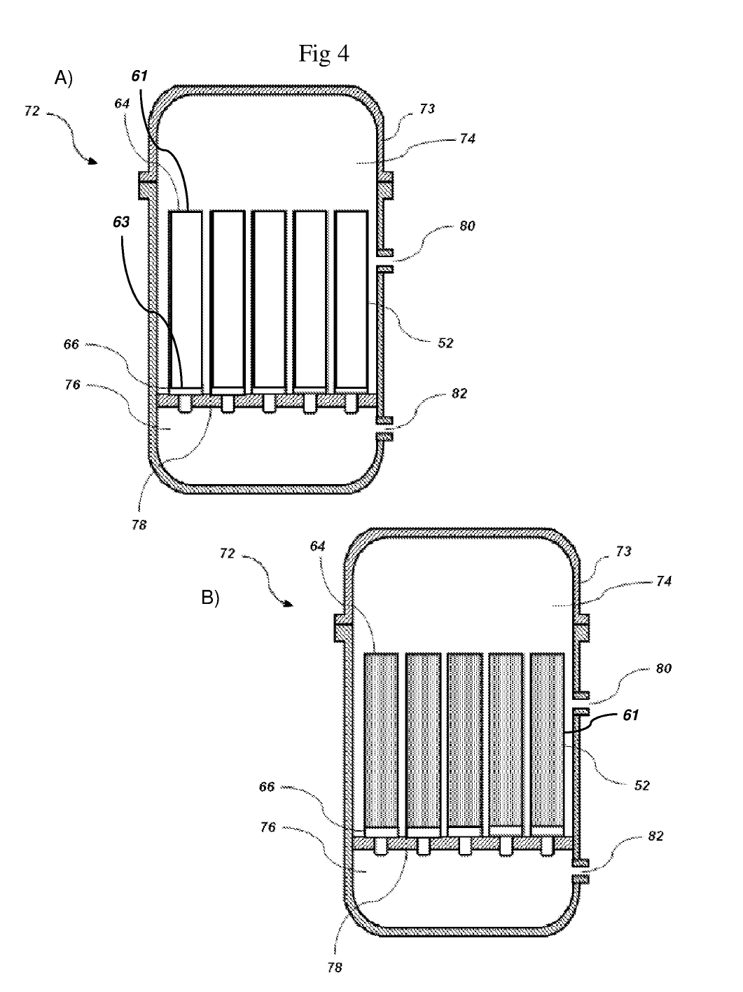

A plurality of bioreactors may be arranged in a parallel (FIG. 4) or serial arrangement (FIG. 5) within a common pressure vessel; however, in either case, the fluid flow pathway through the bioreactors is preferably a parallel flow pattern. In preferred embodiments, the fluid flow pathway is parallel through the bioreactors of an upstream bioreactor assembly, but bioreactors are positioned in a serial arrangement within a cylindrical inner chamber of the cylindrical pressure vessel.

FIG. 4 illustrates another embodiment of a bioreactor assembly (72) including a pressure vessel (73) which defines a first (74) and second (76) chamber separated by a divider (78) including a first port (80) in fluid communication with the first chamber (74) and the second port (82) in fluid communication with the second chamber (76). The bioreactors (52) may be spiral wound and positioned in a parallel arrangement within the pressure vessel with the inlet scroll face (64) of each bioreactor in fluid communication with the first chamber (76) and an end cap secured to the outlet scroll face (66) of each bioreactor in fluid communication with the second chamber (78). A fluid to flow pathway extends from the fluid feed source (not shown) into the first port (80) of the pressure vessel (73), into the first chamber (74), through the inlet scroll face (64) and outlet scroll face (66) of the bioreactors (52), into the second chamber (76) of the pressure vessel and out of the second port (82) of the pressure vessel. FIG. 4A illustrates multiple bioreactors (52) configured for axial flow and having inlet regions (61) and outlet regions (63) near the corresponding ends of the bioreactors. For comparison, the bioreactors (52) in FIG. 4B are suitable for radial flow and are shown with an inlet region (61) near the bioreactors' outer peripheral surfaces (55).

FIGS. 5 and 7 illustrate embodiments of a bioreactor assembly (72) including a pressure vessel (73) including an inner chamber (84) having a first port (80), second port (82), and inner peripheral surface (81). The spiral wound bioreactors (52) are positioned in a serial arrangement within the pressure vessel (73). FIGS. 5A and 5C illustrate embodiments, where an open cavity (69) at one end of the bioreactor (52) can enable feed exiting the scroll face to enter a central conduit (70). As generally indicated by arrows in these figures, a fluid flow pathway extends from a fluid feed source (not shown) through the first port (80) and into the chamber (84) of the pressure vessel (73), through the inlet scroll faces (64) and out of the outlet scroll faces (66) of the bioreactors (52), and out of the second port (82) of the pressure vessel (73). In FIG. 7a, a fluid flow pathway extends from a fluid feed source (not shown) through the first port (80) and into the chamber (84) of the pressure vessel (73), through the outer peripheral surface (55) of the bioreactor, into the center conduit (70), and out of the second port (82) of the pressure vessel (73). As with the embodiment illustrated in FIG. 4, the fluid flow pathway in these embodiments generally follows a parallel flow pattern through the bioreactors. (The term “parallel” is not intended to refer to the physical orientation, but rather implies that the fluid flow path is divided into two or more equivalent (parallel) paths through different bioreactors before recombining.) In one preferred embodiment, the bioreactors (52) include a center conduit (70) as illustrated in FIG. 3B, wherein the conduits (70) of the bioreactors (52) are in fluid communication with each other and the outlet (82).

In FIGS. 5A and 7A, the bioreactors are shown centered within the pressure vessel. FIGS. 5B, 7B, and 7D are cross sections perpendicular to coincident axes (Y, Y′) of the bioreactor (Y) and bioreactor pressure vessel (Y′). By contrast, FIGS. 5d and 7c illustrate corresponding cases where bioreactors (52) in series are positioned by spacers (79) off-center within the pressure vessel (73), so that Y and Y′ are misaligned. In some cases, this off-center positioning may reduce the overall resistance to feed flow within the vessel. The ratio between the largest and smallest distances between the outer peripheral surface (55) of the bioreactor and the pressures vessel's inner peripheral surface (81) is preferably more than 2. In some embodiments, a plurality of spacers (79) touching the outer peripheral surface (55) of the bioreactors (52), separate the bioreactors (55) from the vessel inner peripheral surface (81). In some cases, it may be necessary to provide a coupler or modify vessel end adapters so that the permeate tube may be off-center.

FIG. 7A-D illustrate embodiments where feed flows radially through bioreactors (52). to Similar to the geometry shown in FIG. 6, the bioreactors (52) may comprise a bio-growth media that defines flow channels that fluidly connect a central hollow conduit (70) with the surrounding porous outer surface (55). FIGS. 7B, 7C, and 7D illustrate variations of radial feed flow channels (68) within the bioreactor. The relatively random flow directed generally toward (or alternatively away from) the central conduit in FIG. 7B is well suited for packed particulates, random fibrous material, or netting. The generally spiraling flow in FIG. 7C (designated by arrows) is more typical of a bioreactor having spiral winding of sheets and feed spacers, but when the bioreactor is designed to produce primarily radial flow instead of axial flow. For instance, radial feed flow within the bioreactor may be favored by allowing feed flow through the periphery and using end caps to block feed flow through the opposing ends (60, 62) (best shown in FIG. 6B).

FIGS. 5A, 5C, and 7A each depict four bioreactors (52) serially arranged within the pressure vessel (73). However, a preferred embodiment includes more than 4 bioreactors serially loaded within a pressure vessel, preferably more than 8 bioreactors within a vessel. With longer pressure vessels and shorter bioreactor modules, capital costs decrease to provide a flow of pre-treated water to a downstream apparatus (assuming similar flow velocities through the bioreactors). A bioreactor with shorter path length through the media will also have less pressure drop. Finally, applicants have also determined that the greatest fraction of bio-growth within the bioreactor took place in the first few inches. For all these reasons, a design allowing parallel flow through multiple bioreactors arranged in series is especially beneficial.

In preferred embodiments, feed flow into and out of a vessel containing multiple bioreactors may be at least four times more than feed entering a downstream hyperfiltration vessel, even if normalized to the cross sectional area of the two pressure vessels (38), (73). At these unusually high flow rates through a vessel, there can be a large pressure drop in the annular region surrounding the bioreactor and in the central hollow conduit. There is also potential for a large pressure drop through the central hollow conduit. Further, calculations have determined that pressure drops down the vessel at these two locations will not cancel, and large variations in flow through different bioreactors at different positions down the vessel can result. It is preferred that variation in water flow between bioreactors within a pressure vessel be kept within less than a factor of two, preferably less than 1.5.

While a pressure vessel containing a plurality of packed spiral wound bioreactors would maximize the incorporation of bio-growth surfaces (media), a preferred embodiment of the bioreactor assembly includes multiple parallel bioreactors within a pressure vessel and substantial free space along the fluid flow pathway, between the outer periphery of the bioreactors and inner peripheral surface of the inner chamber of the pressure.

In order to provide a robust fluid flow pathway, the bioreactors preferably have a smaller outer diameter than the diameter of the inner chamber of the pressure vessel. In still more preferred embodiments, the inner chamber of the pressure vessel extends along an axis (Y′) between opposing ends. At least 15% (and more preferably 20%, 25% or even 30%) of the cross-sectional area (i.e. taken in a perpendicular direction to axis Y′ and at any location along the axis Y′) of the inner chamber, excluding the area of the flow channels (of bioreactors that may be located at the point at which the cross section is measured), is free space accessible to the fluid flow pathway. This arrangement provides adequate fluid flow through the inner chamber to supply each bioreactor with a parallel flow of feed fluid with reduced pressure drop.

In another embodiment, different from those illustrated in FIGS. 5A, 5C, and 7A, the pre-treated water that passes through the outlet regions of a bioreactor is removed from two different ends of the vessel. (This is similar to the geometry shown in FIG. 2B for hyperfiltration modules, and it results in reduced pressure drop flow within the central hollow conduit. However, it can be more significant in this case due to the larger anticipated pressure drop at the higher flows.) Related to this, the pressure vessel containing bioreactors may include three ports, two on opposing ends and one in the middle. In another embodiment, the difference in flows between bioreactors within a vessel may be reduced by applying flow restriction differently to individual bioreactors. For instance, using smaller holes in the hollow conduit for passage of fluid would decrease energy efficiency of the assembly (greater pressure drop), but it would also improve uniformity. Similarly, providing flow restrictors within the hollow conduit can be used to reduce flow from specific locations of higher flow.

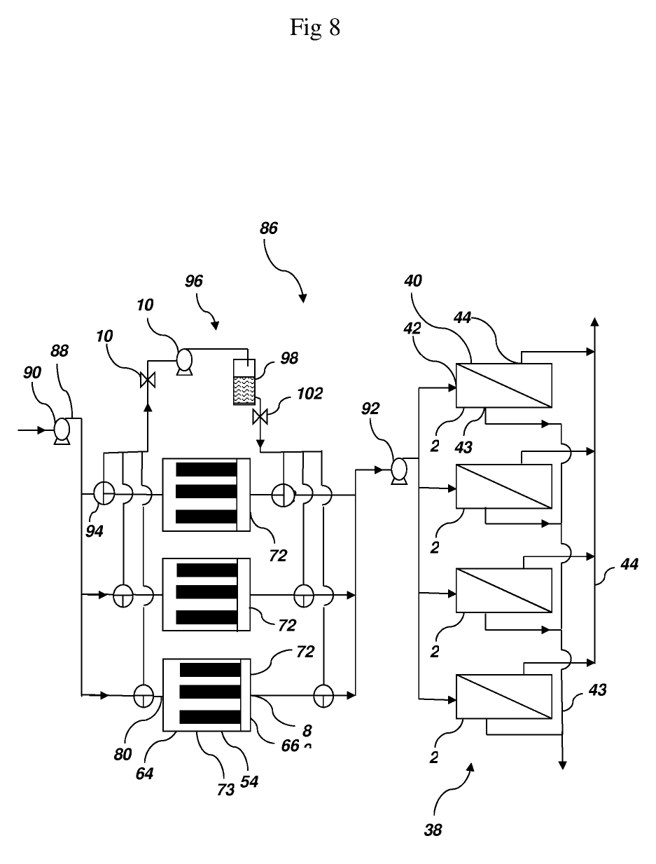

FIG. 8 schematically illustrates an embodiment of a treatment assembly (86) including a plurality of bioreactor assemblies (72, 72′) adapted for connection to a source of pressurized feed fluid (88) and positioned upstream from a plurality of hyperfiltration assemblies (38). Bioreactors (52) within the bioreactor assemblies (72, 72′) may be positioned in either a parallel or serial arrangement within the pressure vessel (73). In one embodiment, the bioreactors (52) comprise spiral wound sheets (54) and feed spacers (58). In another embodiment, bioreactors (52) comprise a hollow central conduit (70) and a porous outer surface (55) containing media (e.g. particles, fibers, netting/spacer, sheets) that provide bio-growth surfaces and define flow channels that fluidly connect the central hollow conduit with the surrounding porous outer surface. Representative feed fluids include brackish water, sea water and waste water. The assembly may include one or more pumps (90, 92) for producing the desired fluid pressure. Preferably, a pump (92) exists at least between a low pressure vessel (73) for bioreactors (52) and a high pressure vessel (40) for hyperfiltration membrane modules (2). The assembly (86) includes a fluid flow pathway (generally indicated by arrows) extending from the fluid feed source (88) and into the first ports (80) of the low pressure vessels (73), through the bioreactors (52) and out the second port (82), into the feed ports (42) of the high pressure vessels (40), through the membrane modules (2) and out of the concentrate ports (43) and permeate ports (44). Concentrate (43′) and permeate (44′) from a plurality of hyperfiltration assemblies (38) may be combined and optionally subject to additional treatment, e.g. further treatment with hyperfiltration assemblies (not shown). The bioreactor assemblies (72) and to hyperfiltration assemblies (38) may be connected by way of standard piping, valves, pressure sensors, etc. In a preferred embodiment, the bioreactor assemblies and hyperfiltration assemblies are sized such that the pressure drop for flow through a bioreactor assembly is less than 10% of the pressure drop through a hyperfiltration assembly (as measured at start up using non-fouled assemblies using pure water at 25° C. and a flow rate through the hyperfiltration assembly(ies) of 15 gfd). In a preferred embodiment of the filtration system, the total area of bio-growth surface within the bioreactor assembly(ies) is greater than sum total of membrane area contained within the lead (first in series) hyperfiltration modules in the subsequent stage of parallel high pressure vessels. The hyperfiltration assemblies are preferably operated at a permeate recovery of at least 90% and more preferably 95%. This high level of permeate recovery operation is sustainable due to the biofouling prevention provided by the upstream bioreactor assembly.

In the embodiment shown in FIG. 8, valves (94) are positioned near the first and second ports (80, 82) of each bioreactor assembly (72). The valves (94) allow a bioreactor assembly (72) to be isolated from a common source of pressurized feed fluid (88) and other bioreactor assemblies (72′). In this way, an individual bioreactor assembly (72) may be taken off-line while the other bioreactor assemblies (72′) remain in operation with feed fluid passing therethrough. In some embodiments, a portable cleaning system may be connected to isolated bioreactor assemblies (72). In FIG. 8, the treatment assembly (86) includes an optional cleaning assembly (96) including a cleaning flow pathway extending from the first port (80) of a bioreactor assembly (72), through a source of cleaning agent (98), to the second port (82) and through the individual bioreactors (52) within a low pressure vessel (73) to exit assembly (72) at the first port (80).

A bioreactor assembly (72) may alternate between an operating mode and a cleaning mode. In the operating mode, fluid from the first port (80) passes through parallel bioreactors (52), from inlet scroll face (64) to outlet scroll face (66), exiting the bioreactor assembly at its second port (82). The cleaning flow pathway may be reversed, or combinations of flow directions may be used. The cleaning assembly may include a separate pump (100) and valve assembly (102). The cleaning assembly (96) and related flow path are isolated from the hyperfiltration assemblies (38), and as such, a wider range of cleaning agents may be used without compromising the integrity of the membranes of the hyperfiltration assemblies (38). Representative cleaning agents include acid solutions having a pH of less than 2, basic solutions having a pH greater than 12, solutions including biocides, aqueous solutions at elevated temperature (e.g. greater than 40° C., 60° C. or 80° C.), and oxidants, e.g. aqueous chlorine solutions (e.g. at least 10 ppm, 100 ppm or even 1000 ppm of chlorine). Preferably, the cleaning fluid has an average residence time of less than 10 seconds (1 to 10 seconds) within the bioreactor; more preferably the average residence is less than 5 seconds within the bioreactor.

After cleaning, the bioreactor assembly (72) may be flushed, e.g. with one or more of clean water, feed fluid, or an inoculation solution including microorganisms in a manner similar to that described with respect to the cleaning assembly. The inoculation solution may include liquid previously extracted from the bioreactor assembly (e.g. prior to or during cleaning). A nutrient may also be dosed during at least a part of the operating mode. In a preferred embodiment, the pressure difference across a bioreactor (52) or bioreactor assembly (72) is measured in the operating mode, and switching from the operating mode to the cleaning mode is triggered by the measured pressure difference. Preferably, the pressure difference across the bioreactor assembly (72) is less than 10 psi (more preferably less than 5 psi) after the cleaning mode. In one embodiment, the cleaning mode is commenced after a measured pressure drop of the bioreactor exceeds 10 psi, or more preferably after it exceeds 20 psi.

Many embodiments of the invention have been described and in some instances certain embodiments, selections, ranges, constituents, or other features have been characterized as being “preferred.” Such designations of “preferred” features should in no way be interpreted as an essential or critical aspect of the invention. For instance, it will be appreciated that a spiral wound bioreactor has advantages, but that various alternatives configurations could include hollow fiber, plate and frame, a packed bed of particulates, and a fluidized bed. For other geometries, it is still preferred that the bioreactor be cylindrical, that flow channels (68) extending through the bioreactor have a void volume of at least 65% (more preferably 75% or even 85%) of the volume of the bioreactor, and that the ratio of bio-growth surface area to bioreactor volume for each bioreactor is preferably between 15 cm⁻¹ and 150 cm⁻¹ (more preferably between 20 cm⁻¹ and 100 cm⁻¹).

Additional embodiments and features are described in: U.S. 62/148,365 (PCT/US15/051297); U.S. 62/148,348 (PCT/US15/051297) and U.S. 62/054,408 (PCT/US15/051295). The entire content of each of the aforementioned patents and patent applications are incorporated herein by reference.

1. A bioreactor assembly for treating feed water comprising:
i) a pressure vessel (73) comprising an inner peripheral surface defining an inner chamber having a cross-sectional area, and a first and second port adapted to provide fluid access with the inner chamber,
ii) a plurality of bioreactors (52) located within the inner chamber, wherein each bioreactor includes an outer periphery and flow channels extending along bio-growth surfaces from an inlet region to an outlet region, and
iii) a fluid flow pathway adapted for connection to a source of feed water and extending from the first port of the pressure vessel, along a parallel flow pattern to each bioreactor, into the flow channels of each bioreactor, and out the second port of the pressure vessel.

2. The assembly of claim 1 wherein the bioreactors are positioned in a serial arrangement within the inner chamber of the pressure vessel.

3. The assembly of claim 1 wherein: i) the inner chamber of the pressure vessel extends along an axis (Y′) between opposing ends, and ii) at least 15, 20, 25, 30% of the cross-sectional area of the inner chamber, excluding area of the flow channels, is free space accessible to the fluid flow pathway.

4. The assembly of claim 1 wherein the outer periphery of the bioreactors define a volume, and wherein the flow channels comprises at least 65% of the volume of the bioreactor.

5. The assembly of claim 1 further comprising at least one spacers located between the outer periphery of the bioreactors and the inner peripheral surface of the pressure vessel, wherein the spacer maintains the fluid flow pathway between the inner peripheral surface of the pressure vessel and the outer periphery of the bioreactors.

6. The assembly of claim 1 wherein the outer periphery of the bioreactors define a volume, the bio-growth surfaces have a surface area, and the ratio of bio-growth surface area to bioreactor volume is between 15 cm-1 and 150 cm-1.

7. The assembly of claim 1 further comprising a plurality pressure vessels each comprising a plurality of bioreactors, and wherein the individual pressure vessels are located in a parallel arrangement with respect to the fluid flow pathway extending from the source of feed water, and wherein each pressure vessel includes a valve for blocking flow from a pressure vessel such that it may be isolated from the source of feed water.

8. The assembly of claim 1 further including a filtration device located downstream and in fluid access with the second ports of the pressure vessels, and wherein the pressure vessels collectively provide a source of treated feed water to the filtration device.
